(19) United States
(12) Patent Application Publication
(10) Pub. No.: US 2006/0049211 A1
(43) Pub. Date: Mar. 9, 2006

(54) Ice cream scoop with interchangeable element

(76) Inventor: Bryant Nevitt, Anaheim, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/936,040

(22) Filed: Sep. 7, 2004

(51) Int. Cl. G01F 11/00

(52) U.S. Cl. 222/386

(57) ABSTRACT

An ice cream cutting and dispensing apparatus includes a handle providing a rotating lever and an axially moving plunger engaged proximally with the lever. The lever is operable between a relaxed position, placing the plunger in a retracted position, and a depressed position, placing the plunger in an extended position. A pair of guide pins are fixed to the handle and extend downwardly therefrom in parallel with the plunger. A cylindrical cutter is engaged with the handle in axial orientation by at least two male-to-female snap-action fasteners enabling the cylindrical cutter to be replaced by one of a different shape. A presser plate is removably fixed distally on the plunger and movable therewith for reciprocating motion within the cylindrical cutter by action of the lever. The presser plate, conforming to the cylindrical cutter in shape, provides clearance holes for admitting the guide pins.

### 1. RELATED APPLICATIONS

none

### 2. INCORPORATION BY REFERENCE

Applicant hereby incorporates herein by reference, the U.S. patents and U.S. patent applications, if any, referred to in the Description of Related Art section of this application as filed.

### BACKGROUND OF THE INVENTION

1. Field of the Invention

This invention relates generally to food handling equipment and devices, and more specifically to a hand deployed ice cream cutter and dispenser.

2. Description of Related Art

The following art defines the present state of this field and each disclosure is hereby incorporated herein by reference:

Prince et al, U.S. Des 156,559, describes a design for a server for ice cream, potatoes, or the like.

Adams, U.S. Des 314,121, describes an ice cream dispensing device or similar article.

Levy, U.S. Pat. No. 1,352,755, describes a mechanism of the nature described, the combination of a handle and a hollow, flattened body rigid with and extending in the same direction as the handle, a plunger head located transversely within the body and having its lower edge rounded transversely to its length, and a stem attached to the plunger and guided by the handle.

Manos, U.S. Pat. No. 1,529,319, describes a casing, a plunger shiftable within the casing for expelling the contents of the latter, a spring normally holding the plunger retracted, a lever for advancing the plunger, a shearing blade for rotary movement across the front end of the casing, a spring for actuating the blade in one direction, means normally locking the blade against movement, and means for dislodging the locking means at the limit of advance movement of the plunger.

Manos, U.S. Pat. No. 1,561,558, describes a tubular casing, means reciprocable within the casing for expelling the contents of the latter, a longitudinally slotted handle attached to the casing, the casing having therein a slot in communication with the slot of the handle, a lever disposed in the handle slot and having pivotal connection with the expelling means, the lever being pivoted to the handle adjacent to the rear end of the slot and a gear segment on the rear end, a pivoted member having a gear segment operatively engaged with the gear of the lever and a spring associated with the member serving to maintain the latter in outwardly thrust relative to said handle.

Pearce, U.S. Pat. No. 1,661,734, describes a hollow cylindrical member open at both ends, a rod of small cross section area located across and secured to the lower end of the member, a head secured in and closing the upper end of the member, a push rod slidably mounted on and passing through the head, a circular disc attached to the lower end of the push rod coupling ring formed between its upper and lower edges and at its inner side with an inwardly extending ledge against which the lower edge of he cylindrical member may bear when the coupling ring is placed over it.

Mills, U.S. Pat. No. 1,703,243, describes an ice cream cutter, mold and server, the combination of an inverted hollow body surmounted by a tubular plunder guide, a plunger rod reciprocally mounted in the guide, an operating handle projecting laterally from the guide, a push bar on the projecting end of the rod and a plunder head on the opposite end.

Patzer, U.S. Pat. No. 1,705,533 describes a dispensing device having an open bottom container, an ejecting disk slidably mounted in the container, a shank rising from the disk through the top of the container and provided with graduated stops in one edge, a pressure element mounted above the container, a spring-pressed pawl carried by the element and adapted to engage a selected stop on the shank, and means normally holding the pawl out of engagement with the shank.

Clave, U.S. Pat. No. 2,154,806, describes an ice cream slice making device with a vertically disposed housing opening downwardly with the edges sharpened, a hollow elongated shank extending integrally front the upper part of the housing and a hand hold at the upper extremity of the shank, expansible spring means within the housing and normally contacting and bearing against opposite inside walls of the housing, a reciprocable rod within the shank and one end thereof secured to the spring members, means for reciprocating the rod and spring members to move the latter out of the open end of the housing.

Barry, U.S. Pat. No. 2,786,429, describes an ice cream scoop of very simple construction, the scoop being automatically operative to eject the ice cream from the mold after it has been thrust into the ice cream in order to fill the mold. The automatic operation takes place by releasing a finger-grip bar thereby permitting the stored energy in a spring to be applied against the ice cream ejector in order to discharge the ice cream from the mold. The square shape facilitates its operation in removing ice cream from square containers.

Lea, U.S. Pat. No. 2,859,325, describes a dispenser or dipper for ice cream or other frozen foods. More, particularly, the invention has incorporated a tubular receiver for the food, which receiver has in its wall an electrical heating element. On energizing of the element the receiver is capable of easily penetrating a frozen substance by reason of melting the substance where the same contacts the wall of the receiver. On full penetration of the substance by the receiver, the device is adapted, responsive to de-energization of the heating element, to cause the substance to adhere to the wall of the receiver for extraction therewith from the container in which said substance is normally confined. Subsequently, re-energizing the heating element once again, the substance is adapted to gravitate from the receiver to be dispensed upon a plate or similar receptacle.

Wells, WO 0022936, describes a dispensing device for dispensing frozen dessert from pre-filled containers of frozen dessert. Each container includes a tubular housing having a nozzle at a first end and a piston locate for sliding movement within the tubular housing to extrude the frozen dessert within the container through the nozzle. The dispensing device includes a frame member, a support means for supporting a pre-filled container in position for dispensing the frozen dessert, a plunger for engaging the piston of a container supported on the support means, and a drive lever for driving the plunger to dispense frozen dessert from the contains. The support means is attached to the frame member by a first pivot means. The plunger is attached to the drive lever by a second pivot means. The drive lever is attached to the frame member by a third pivot means. This arrangement is such that the dispensing device may be unfolded for use or folded substantially flat for use or folded substantially flat for storage.

Our prior art search with abstracts described above teaches: a design for a server for ice cream and other soft foods, a design for an ice cream dispensing device, an ice cream dipper, an ice cream scoop, two combined scoop and mold devices for ice cream, two ice cream dispensers, an ice cream mold, an ice cream measurer and dipper, an electrical ice cream dispensing gun device, and a dispenser for dispensing frozen dessert from pre-filled containers. Thus, the prior art teaches various devices designed to be pressed into ice cream to pick up a quantity and with levers of various types for releasing the ice cream to a plate, cone and the like. Such devices dispense ice cream in a variety of shapes. However, the prior art fails to teach such an ice cream dispensing device with an assortment of scoop shapes that may be used interchangeably. The present invention fulfills these needs and provides further related advantages as described in the following summary.

### SUMMARY OF THE INVENTION

The present invention teaches certain benefits in construction and use which give rise to the objectives described below.

In the preferred embodiment of the present invention, an ice cream cutting and dispensing apparatus includes a handle providing a rotating, hand operated lever and an axially moving plunger engaged proximally with the lever. The lever is operable between a relaxed position, placing the plunger in a retracted position, and a depressed position, placing the plunger in an extended position. A pair of guide pins are fixed to the handle and extend downwardly therefrom in parallel with the plunger. A cylindrical cutter is engaged with the handle in axial orientation by at least two male-to-female snap-action fasteners enabling the cylindrical cutter to be replaced by one of a different shape. A presser plate is removably fixed distally on the plunger and movable therewith for reciprocating motion within the cylindrical cutter by action of the lever. The presser plate, conforming to the cylindrical cutter in shape, provides clearance holes for admitting the guide pins.

A primary objective of the present invention is to provide an apparatus and method of use of such apparatus that yields advantages not taught by the prior art.

Another objective of the invention is to provide a manual tool for cutting and dispensing ice cream in a selected shape.

A further objective of the invention is to provide such a tool with interchangeable elements for cutting ice cream into a variety of selected shapes.

A still further objective of the invention is to provide a snap-action element for joining a cutting blade portion of the invention with a handle of the invention.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is an exploded perspective view of one embodiment of the present invention showing a round scoop and presser plate;

FIG. 2 is a perspective view thereof as assembled;

FIG. 3 is a partial sectional view thereof taken along line 3-3 in FIG. 2;

FIG. 4 is a perspective view of a square scoop and presser plate used with the invention;

FIG. 5 is a perspective view of a star-shaped scoop and presser plate used with the invention; and

FIG. 6 is a perspective view of a heart-shaped scoop and presser plate used with the invention.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

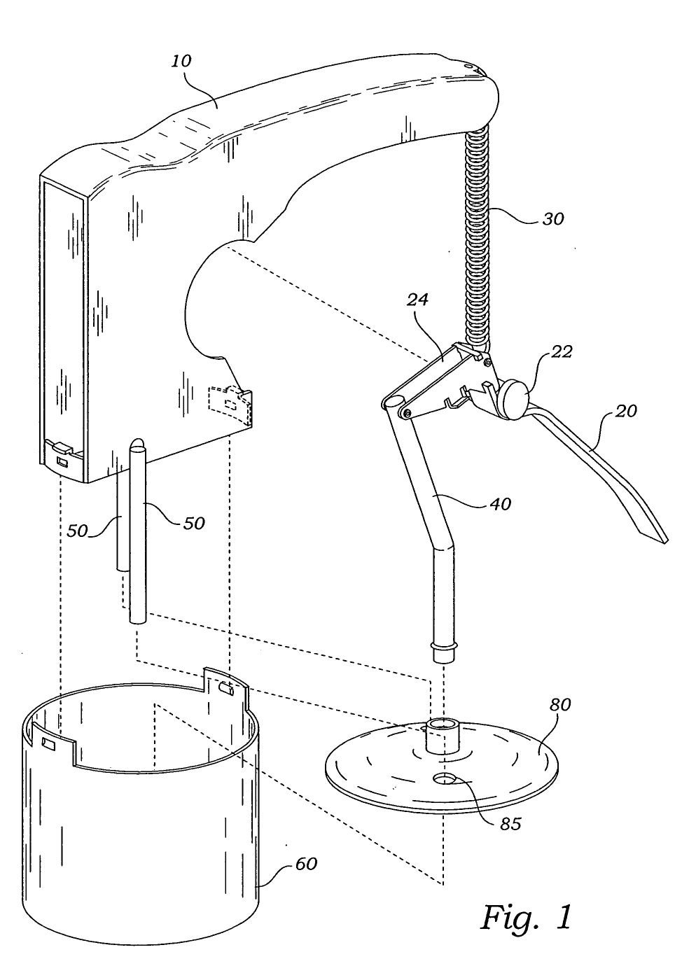

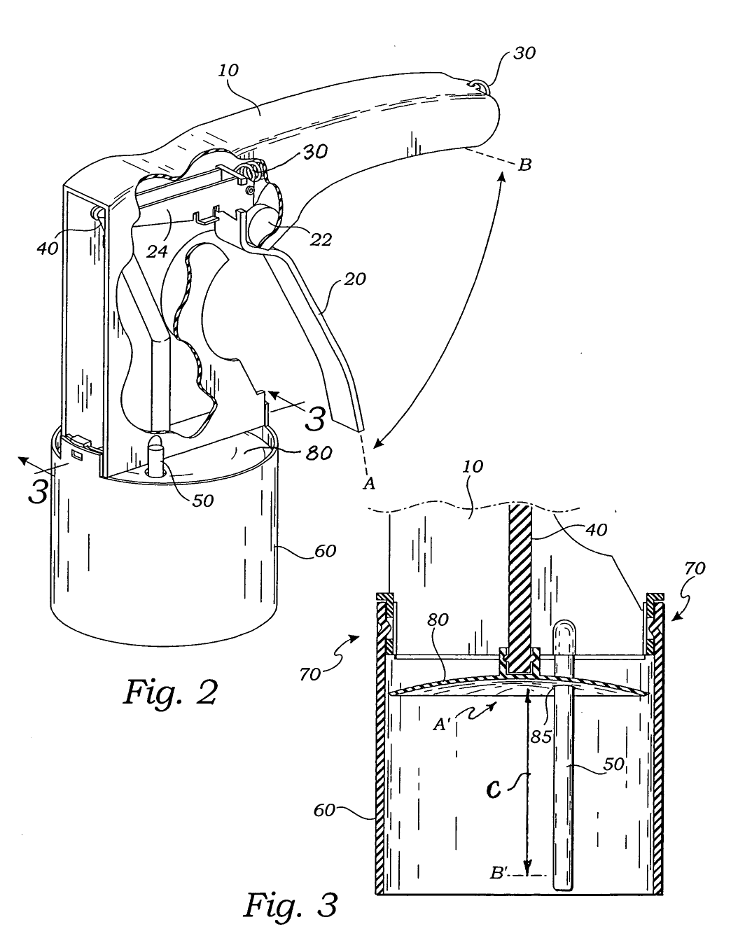

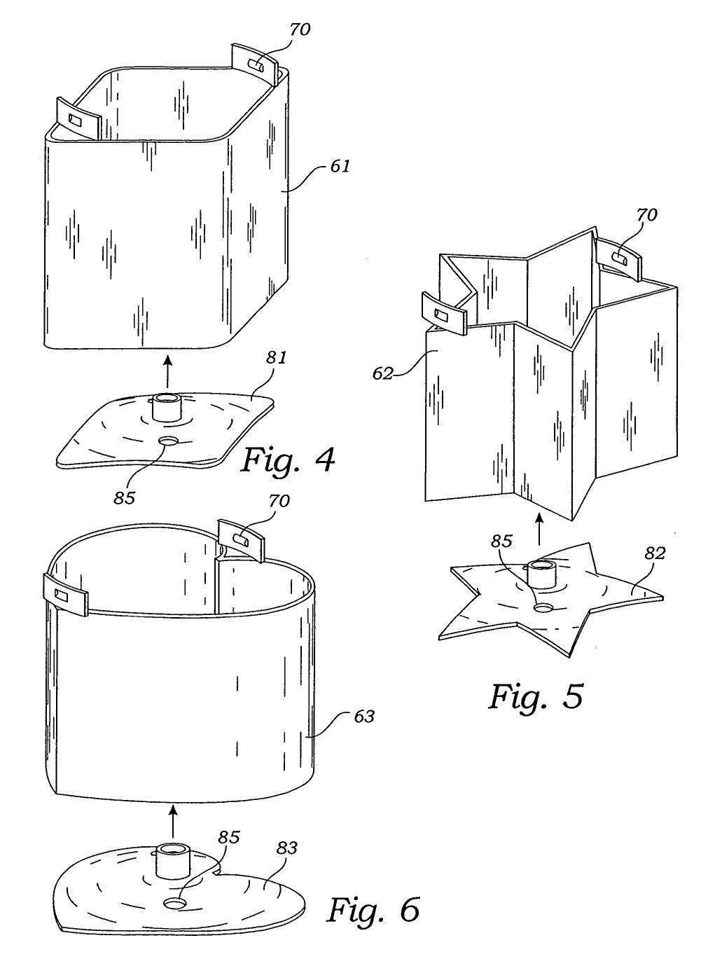

In one embodiment of the present invention an ice cream cutting and dispensing apparatus comprises a handle 10 providing a rotating lever 20 which is mounted in the handle by hinge pin 22 and about which the handle rotates. The lever 20 rotates between positions A and B, as shown in FIG. 2. Lever 20 includes pivot piece 24 which is attached to one end of spring 30, with the other end of spring 30 fixed at the distal end of handle 10. This is best seen in FIG. 2. The pivot piece 24 also pivotally engages plunger 40 proximally, and plunger 40 is thus positioned to move axially in an up and down motion, as shown in FIGS. 2 and 3. The lever 20 is operable between relaxed position A (FIG. 2) which places the plunger 40 in a retracted position A′ shown in FIG. 3, and a depressed position B, placing the plunger 40 in an extended position B′, again shown in FIG. 3. Preferably, a pair of guide pins 50 are fixed (preferably welded) proximally to the handle 10 and extend in parallel to each other and to the plunger 40 as seen in FIG. 1. At least one, and preferably, a plurality of cylindrical cutters 60, 61, 62, 63, each have a distinct shape as shown in FIGS. 1-3, 4, 5 and 6 respectively. Any one of the cutters, interchangeably, may be engaged with the handle 10 in axial orientation, preferably by two male-to-female snap-action fasteners 70. Fasteners 70 comprise slots 70′ in handle 10 and displaced portion 70″ in cutters 60-63. The selected cutter is placed as shown in FIG. 2, so that displaced portions 70″ snap into slots 70′. Because of the curved or bent conformation of the cutters, as well as the rigid material they are constructed of; preferably stainless steel, the cutters are able to be fully secured on the handle by only the two fasteners 70. This enables one of the cylindrical cutters 60-63 to be replaced by another of the cutters on the handle 10 as desired, by simply pulling one off and pressing the replacement onto the handle 10, so that one may cut a portion of ice cream into a desired shape. Actually, any shape is possible including numerals and letters or other symbols such as Greek letters. A plurality of presser plates 80, 81, 82 and 83, each corresponding in shape to one of the cutters 60-63 is employed as shown in FIG. 3. One of the presser plates is removably mounted on the plunger 40 at its lower or distal end, and is movable therewith in reciprocating motion over displacement range C (FIG. 3) within the corresponding one of the cylindrical cutters by action of the lever 10 and plunger 40. Each of the presser plates 80-83 provides clearance holes 85 for admitting the guide pins 50. As shown in FIG. 3, the distal end of the plunger 40 is removably mounted at the center of the presser plate in a snap-in manner well known to those of skill. Thus, by snap-action, both the cutter and the presser plate may be exchanged.

Preferably, one each of the cylindrical cutters has a round shape 60, a square shape 61, a star shape 62 and a heart shape 63.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. An ice cream cutting and dispensing apparatus comprising: a handle providing a lever; an axially moving plunger engaged proximally with the lever; the lever operable between a relaxed position, placing the plunger in a retracted position, and a depressed position, placing the plunger in an extended position; a cylindrical cutter engaged with the handle in axial orientation by at least two male-to-female snap-action fasteners enabling the cylindrical cutter to be replaced at will; and a presser plate removably engaged with the plunger and movable therewith for reciprocating motion within the cylindrical cutter by action of the lever.

2. The apparatus of claim 1 wherein the presser plate conforms to the cylindrical cutter in shape.

3. The apparatus of claim 1 further comprising at least one guide pin fixed proximally to the handle and extending therefrom in parallel with the plunger through clearance holes in the presser plate.

4. The apparatus of claim 1 wherein the cylindrical cutter conforms to one of: a round shape, a square shape, a heart shape and a star shape.

5. An ice cream cutting and dispensing apparatus comprising in combination: a handle providing a rotating lever; an axially moving plunger engaged proximally with the lever, the lever operable between a relaxed position, placing the plunger in a retracted position, and a depressed position, placing the plunger in an extended position; a plurality of cylindrical cutters, each having a distinct shape, one of the cutters engaged with the handle in axial orientation by at least two male-to-female snap-action fasteners enabling the one of the cylindrical cutters to be replaced by another of the cutters; and at least one presser plate, removably fixed distally on the plunger and movable therewith for reciprocating motion within the one of the cylindrical cutters by action of the lever.

6. The apparatus of claim 4 wherein the at least one presser plate is a plurality of such presser plates, each corresponding in shape to one of the cutters.

7. The apparatus of claim 4 wherein the cylindrical cutters are of a round shape, a square shape, a heart shape and a star shape respectively.

8. The apparatus of claim 4 further comprising at least one guide pin fixed proximally to the handle and extending therefrom in parallel with the plunger; the at least one presser plate providing at least one clearance hole for admitting the at least one guide pin.
